(19) United States
(12) Patent Application Publication
(10) Pub. No.: US 2026/0111220 A1
(43) Pub. Date: Apr. 23, 2026

(54) System

(71) Applicant: Softbank Group Corp., Tokyo (JP)

(72) Inventor: Shuhei Takahara, Tokyo (JP)

(21) Appl. No.: 19/360,808

(22) Filed: Oct. 16, 2025

(30) Foreign Application Priority Data
Oct. 21, 2024 (JP) 2024-185497

(51) Int. Cl. G06F 8/73; G06F 8/75; G06F 9/451; G06Q 10/10; G09B 19/00

(52) U.S. Cl. CPC G06F 8/73; G06F 8/75; G06F 9/453; G09B 19/0053

(57) ABSTRACT

A system includes a processor that is configured to automatically scan all software code and identify the role and relationships of each code file, extract the overall design concept of the system based on metadata of the analyzed code, generate educational reduced code that retains the core functions of the project while making it easier to understand, and generate answers to user questions based on the overall design concept of the project.

### CROSS-REFERENCE TO RELATED APPLICATION

This application is based on and claims priority under 35 USC 119 from Japanese Patent Application No. 2024-185497 filed on Oct. 21, 2024, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

In large-scale software development projects, there is often a significant dependency on specific engineers or vendors who possess specialized knowledge about the project's architecture and implementation. This dependency can hinder efficient knowledge transfer, complicate project onboarding for new team members, and impede smooth project progression, especially in the event of personnel turnover. Furthermore, the lack of comprehensive and accessible educational materials for new participants and the absence of systematic feedback collection make it difficult to continuously enhance the learning environment and system functionality.

### SUMMARY

To address these issues, the present invention provides a system comprising a processor that automatically scans all software code in a project and identifies the role and relationships of each code file. The processor extracts the overall system design concept based on the metadata obtained from the code analysis and generates educational reduced code that maintains the core functions of the project for easier understanding. Moreover, the processor generates answers to user questions in accordance with the project's overall design concept, provides interactive tutorials for new participants using analyzed information, and continuously collects user feedback for system improvement. This enables rapid knowledge sharing, efficient onboarding of new team members, and ongoing system optimization without relying on specific individuals.

“Processor” means a hardware device or logical unit capable of performing automated computation and control operations within the system. “Software code” means a collection of source files written in programming languages that constitute the operational logic of a software project. “Scan” means to systematically examine all software code files within a specified project for analysis purposes. “Role” means the primary function or responsibility assigned to an individual code file within the overall project architecture. “Relationship” means the dependencies and connections between different code files or modules in a software project. “Metadata” means structured data containing summarized information derived from analyzing software code, including file attributes, functions, and interrelations. “Design concept” means the overarching architectural principles, patterns, and logic structure that define the software project as a whole. “Educational reduced code” means a simplified version of the software code, retaining essential functionality but designed to facilitate understanding and education for learners or new participants. “User question” means a formal inquiry submitted by a user regarding the structure, function, or operation of the software project. “Interactive tutorial” means a guided, step-by-step instructional program, utilizing reduced code and existing project information, designed to enhance user learning and engagement. “User feedback” means responses, evaluations, or suggestions provided by users based on their experience with the system or tutorials. “System functionality improvement” means the process of modifying and upgrading the operational features of the system based on collected user feedback and analysis.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

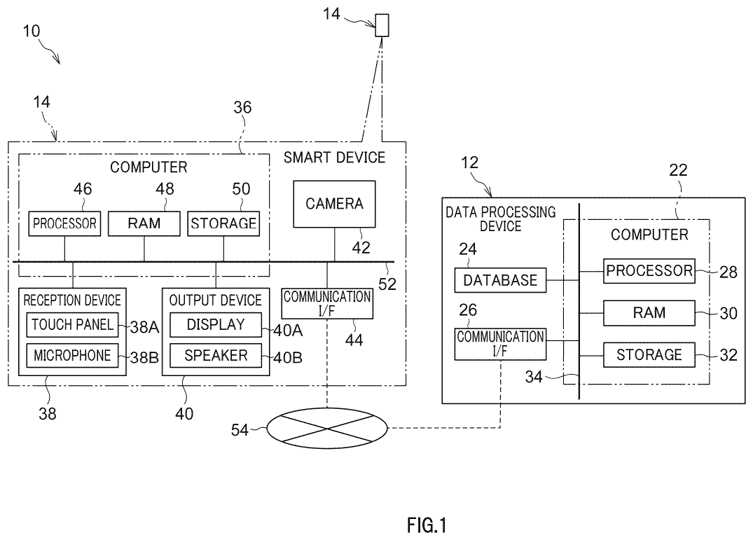

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

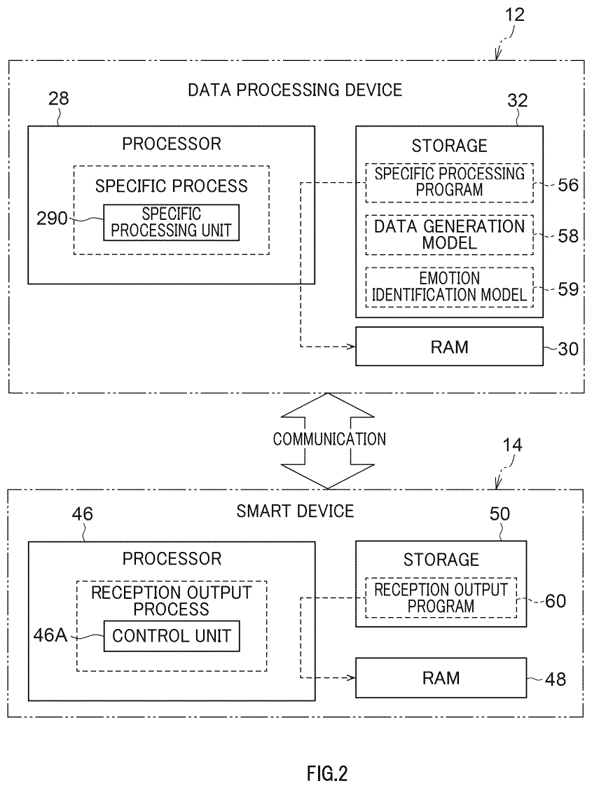

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples.

Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

In conventional system development environments, significant challenges arise due to excessive dependence on specific engineers or vendors, resulting in inefficiency during project progression and in onboarding new team members. Understanding the full structure and intent of complex software projects often requires extensive time and effort, making it difficult for newcomers to rapidly adapt and contribute. Additionally, addressing technical questions and implementing system changes are often delayed due to unclear documentation or limited knowledge sharing. There is a need for a system that can autonomously analyze software code, extract system design policies, and facilitate efficient knowledge transfer and onboarding for new users, while providing responsive, context-aware answers about the system architecture and implementation details.

The specific processing by the specific processing unit 290 of the data processing device 12 in Example 1 is realized by the following means.

The present invention provides a server comprising a processor configured to automatically scan a plurality of software code description data, identify their functions and interrelationships, extract system design policy based on structural information of the analyzed software code, generate a reduced learning software code example that maintains the fundamental operations of the system, provide an interactive educational environment via a terminal device, and generate context-based explanations by inputting user questions and extracted design information into a generative model. This enables efficient onboarding of new participants, autonomous knowledge extraction and transfer, and immediate, precise responses to queries regarding the project structure and implementation, thereby reducing reliance on specific individuals and improving the efficiency and reliability of software project management.

The term “software code description data” refers to data representing a set of instructions written in a programming language, which is used to define the behavior, structure, and operations of an information processing system. The term “function” refers to a specific operation, role, or behavior implemented within a software code description data, which performs a designated task as part of the information processing system. The term “interrelationship” refers to the logical or structural connection between multiple software code description data, including dependencies, usage relationships, and data flow among the components of an information processing system. The term “design policy” refers to the overarching architectural concepts, design patterns, or guiding principles that define how the components of an information processing system are organized and interact with each other. The term “structural information” refers to metadata or analytical data describing the composition, hierarchy, dependencies, and relationship of software code description data within an information processing system. The term “reduced learning software code description data” refers to a simplified or minimal subset of software code description data generated from the original code base, maintaining core functions necessary for understanding and education while excluding details unnecessary for instructional purposes. The term “interactive educational information processing environment” refers to a user interface or platform, typically provided on a terminal device, which allows a user to interact with, modify, execute, and learn from software code description data in a guided and dynamic manner. The term “terminal device” refers to a hardware device, such as a personal computer, tablet, or smartphone, used by a user to interact with the information processing system and access educational or instructional content. The term “question sentence data” refers to natural-language input provided by a user, representing a request for information or clarification regarding the software code description data, its functions, or system design. The term “prompt sentence” refers to a combined data input, consisting of user question sentence data, design policy information, and structural information, formatted and used as input for a generative model to obtain a relevant response. The term “generative model” refers to an artificial intelligence model capable of generating natural-language responses or explanations based on input data, such as prompt sentences containing context about code structure and design. The term “explanation information” refers to the natural-language content generated for the purpose of clarifying, describing, or interpreting the design, functions, or structure of the information processing system. The term “specific example information” refers to detailed illustrative data, including code snippets or use-case scenarios, provided as concrete references to help users understand implementation or architectural aspects of the system. The term “response information” refers to information generated by or provided to a user in reaction to their interactions, inputs, or requests within the information processing environment. The term “operation history information” refers to a chronological record of actions, commands, or interactions performed by a user within the interactive educational information processing environment.

One embodiment for implementing the invention described in the claims is as follows. The system is primarily composed of a server as an information processing apparatus, one or more terminal devices (such as personal computers, tablets, or smartphones), and a communication network connecting these components. The server includes a processor, storage, appropriate input/output interfaces, and executes the primary processing software required for the invention. The terminal device is operated by a user, and is equipped with an interactive user interface (such as a web-based application) capable of displaying educational content and receiving user inputs. The server is implemented with software operating on a general-purpose operating system (such as Linux). For code analysis, the server uses static code analysis tools—examples include the Python “ast” module or other open-source code parsers (such as ANTLR for various languages). The server utilizes a database management system, for example, PostgreSQL, to store metadata and analysis results extracted from the source code description data. The server is further configured to interface with a generative AI model, such as a large language model hosted on a cloud-based inference platform, through an API. The server receives a plurality of software code description data as input, typically code files written in one or more programming languages corresponding to an entire software project. The server automatically scans these files to extract the structural information, including functions, dependencies, and interrelationships between various files and modules. The server processes the extracted metadata to identify the overall design policy (such as architectural patterns or guiding principles) of the target information processing system. The server determines, for example, whether the software follows a model-view-controller (MVC) pattern by detecting the existence of controller, model, and view components and analyzing their usage relationships. In order to facilitate efficient onboarding and educational experiences, the server automatically generates a reduced learning software code set. This set contains only the core functions necessary to demonstrate the fundamental behavior of the information processing system—such as data registration or database connectivity—and omits complex or peripheral features. The server can utilize the generative AI model to simplify or synthesize key code portions, by constructing and inputting a prompt sentence that concisely describes the required transformation. For example, a prompt sentence to the generative AI model may be: “Extract from the following files only the code necessary to demonstrate user registration and database connection.” or “Summarize the database access logic and provide a minimal example code for educational purposes.” The terminal device downloads the reduced code set and interacts with the user through an interactive educational user interface. The interface presents stepwise instructional content, allows users to view, modify, and execute code snippets, and provides real-time visual feedback. Such an interface is commonly implemented using modern web technologies (such as React.js or Vue.js for the frontend) and in-browser code editors (such as Monaco Editor). The user interacts with the terminal device to perform learning activities, such as running code samples, modifying variables, or responding to step-by-step exercises. Additionally, the user is able to input question sentence data—i.e., questions about the project, system design, or code implementation—through a text input interface provided by the terminal. When the user submits a question, the server constructs a detailed prompt sentence by combining the question sentence data with the previously extracted design policy and structural information. The constructed prompt sentence is then sent to the generative AI model, which returns a natural-language explanation and a specific example based on the actual code and architectural context of the project. Examples of prompt sentences to the generative AI model include: “How is the authentication logic implemented in this project?” “Explain the purpose of the connector module and provide a code example.” “Describe the MVC components identified in the following codebase: [code excerpt]” The server receives the explanation and specific example from the generative AI model, and provides this information back to the terminal device, where it is displayed to the user as part of the interactive educational experience. This structure enables rapid knowledge transfer, context-aware Q&A, and continuous learning, and supports efficient adaptation and skill acquisition for new users.

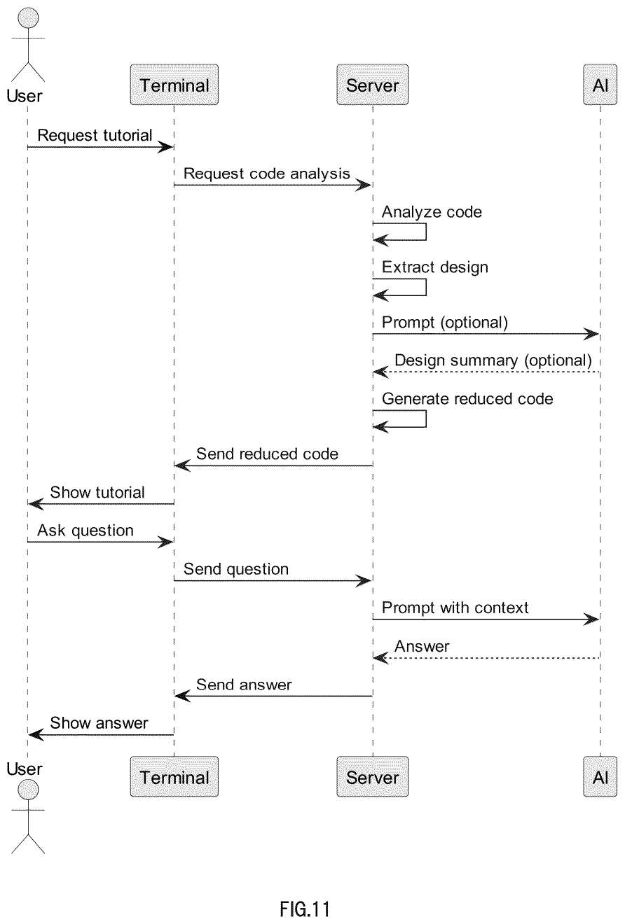

The following describes the processing flow using FIG. 11.

### Step 1

The server receives a set of software code description data as input, such as source code files in various programming languages. The server scans all the input files using static code analysis tools (for example, the Python “ast” module or ANTLR for other languages) and parses the code structure to detect functional units, such as functions, classes, and their dependencies. Based on this analysis, the server generates metadata that describes the functions, usage relationships, and structural hierarchy of the code. The output is a structured set of metadata entries representing code components and their interrelationships, which is stored in a database.

### Step 2

The server processes the metadata produced in Step 1 as input and applies rule-based analysis to discover the design policy of the system, such as the presence of architectural patterns (for example, detecting whether the codebase follows a model-view-controller structure). The server may also construct a prompt sentence and send relevant metadata and code snippets to a generative AI model to summarize the architecture. The output is a set of design policy data and a summary that describes the system's organizational principles, which is saved for subsequent steps.

### Step 3

The server takes as input the design policy data and metadata from Step 2 and generates a reduced learning software code description set, focusing on core functionality needed for educational purposes. The server selects specific files, strips unnecessary code, and organizes the code into a cohesive subset that demonstrates essential behavior, such as login or database access. The server may also send a prompt sentence to a generative AI model, asking it to extract and simplify the relevant code portions. The output is a package containing the reduced code examples and accompanying documentation.

### Step 4

The terminal receives the reduced code package from the server as input and launches an interactive educational application. The terminal displays instructional guides and presents code editing and execution interfaces to the user, often using web technologies such as React.js and Monaco Editor. The terminal allows the user to modify the code, run sample operations, and view immediate feedback. The output is an interactive educational interface where users can experiment with system concepts.

### Step 5

The user interacts with the terminal to perform educational exercises, such as running prepared code samples, editing variables, or completing guided tutorials. The user may also input natural-language question sentence data regarding specific aspects of the code or system design via a text input form. The output is a set of user actions, such as executed code or user queries, which are captured by the terminal.

### Step 6

The server receives the user's question sentence data as input from the terminal and retrieves appropriate context information and relevant code from the database. The server constructs a prompt sentence that includes the user's question, structural metadata, and design policy data, and submits this prompt to a generative AI model. The generative AI model processes the prompt and generates a natural-language explanation and, if suitable, a specific code example. The output is an answer containing explanatory content and examples, which is returned to the terminal.

### Step 7

The terminal receives the server's explanatory answer as input and displays the information to the user, highlighting key code examples and any relevant instructional material. The terminal may also provide follow-up suggestions or links to related exercises. The output is enhanced guidance and contextualized feedback presented to the user, supporting further learning and understanding.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

In conventional software management and education environments for complex systems such as industrial robots, significant challenges arise due to the manual analysis of large codebases, the difficulty of understanding intricate interrelationships among program modules, and the lack of mechanisms for adaptive learning based on user behavior and emotional state. These limitations hinder efficient knowledge transfer, increase training time for new participants, and reduce the responsiveness and personalization of educational support for users with varying backgrounds and needs.

The specific processing by the specific processing unit 290 of the data processing device 12 in Application Example 1 is realized by the following means.

The present invention provides a server comprising an information processor that is configured to automatically analyze program data to identify functional elements and interrelationships, extract structural concepts based on attribute information, generate simplified learning data that preserves core functions, generate response information to user inquiries, adapt output and learning data in accordance with an estimated user emotional state, dynamically present educational content interactively, and optimize system behavior based on user feedback and emotional data. This enables automatic, personalized, and adaptive educational support and software management in complex systems, efficiently promoting understanding and skill acquisition for users with diverse backgrounds and emotional states.

The term “information processing apparatus” refers to a computing device or system capable of executing programmed instructions to process, analyze, and manage electronic data.

The term “program data” refers to electronic information comprising instructions, statements, and modules that are used to operate or control hardware and software within a system. The term “stored data” refers to any digital content or information that is retained in memory or storage media accessible by the computing device. The term “functional elements” refers to individual features, operations, or components within a program that perform specific, defined functions. The term “interrelationships” refers to the logical or operational connections and dependencies that exist among two or more elements, modules, or data within a system. The term “attribute information” refers to metadata describing the characteristics, properties, or roles of particular data or code elements. The term “structural concept” refers to an abstracted model or representation of the relationships, organization, and design patterns present across the entire configuration of a system or software. The term “simplified learning data” refers to a reduced and annotated version of the original program data that preserves essential functions and facilitates understanding for educational purposes. The term “core functions” refers to the fundamental operations or processes necessary for the principal operation of a system or application. The term “external input device” refers to any device or interface that enables a user or another system to communicate inquiries, commands, or data to the server. The term “response information” refers to explanations, instructions, or other content automatically generated by the system in reply to user inquiries. The term “machine learning model” refers to an algorithm or computational framework trained on data and capable of making predictions or inferences, such as estimating emotion from input data. The term “emotional state” refers to a user's current or inferred psychological condition, such as confusion, excitement, or satisfaction, estimated from behavioral or input data. The term “output information” refers to any data, notification, or response that is generated by the system and presented to the user. The term “interactive control device” refers to a human-computer interface capable of dynamically presenting content and receiving user interactions, including but not limited to wearable devices, computers, or mobile terminals. The term “user input history” refers to the collection and record of actions, queries, and interactions submitted by the user during their engagement with the system. The term “generation rules” refers to logic or algorithms governing the creation and adaptation of learning data, response information, or system outputs. The term “evaluation information” refers to feedback or assessment data provided by the user regarding the system's operation, effectiveness, or content. The term “presentation methods” refers to the formats, styles, and protocols by which information and learning content are delivered or displayed to the user.

In one embodiment of the present invention, an information processing system is implemented using a server equipped with a high-performance central processing unit, system memory, persistent data storage, and network communication interfaces. The server operates under a general-purpose operating system such as Linux, and utilizes software components including a web server (for example, an open-source HTTP server), programming language interpreters such as Python, and a graph analysis library for relationship analysis and visualization of program structure. The server receives a complete set of program data that controls a complex system, such as an industrial robot, either through a user-initiated upload or via synchronization with a version control repository. The server automatically analyzes all received program data by parsing each stored file and identifying the functional elements and interrelationships using dedicated parsing libraries, such as Python's ast for Python code or language-agnostic parsers for other programming languages. Extracted metadata, including function names, module dependencies, and documented purposes, are stored in a structured database. Subsequently, the server examines the metadata by applying a structural analysis process, for example using a graph analysis library, to identify overarching design patterns and the program's architecture. This allows the server to extract a structural concept that captures both the relationships and the organization of the system's core functions. By referencing the structural concept and the underlying attribute information, the server automatically generates simplified learning data. This data is a set of code fragments and instructional explanations that focus on the core functions needed for educational purposes and omit unnecessary details. The server uses either custom script generation or a generative artificial intelligence model to produce and annotate educational content tailored to facilitate understanding among diverse users. When a user provides an inquiry through an external input device, such as a wearable terminal or personal computer, the terminal transmits the inquiry to the server. The server uses natural language processing techniques and references the extracted metadata and structural concepts to generate response information containing relevant explanations and implementation details. Optionally, the server may enhance these responses using a generative AI model. In order to further improve the educational experience, the server is equipped with machine learning models capable of estimating the user's emotional state based on the user's textual queries, speech input, or operational patterns. The server adaptively modifies the output information or the content of the learning data in response to the inferred emotional state. If a user is detected to be confused, the server may add clarifying explanations or more detailed step-by-step instructions. The terminal device, which may be a wearable device such as smart glasses or a portable computer, receives the learning data and response content from the server. The terminal dynamically presents this content to the user in an interactive manner, enabling the user to execute, modify, and explore the educational code samples while receiving real-time feedback. The terminal further adjusts the pacing or detail level of the tutorial based on updated instructions from the server, which may be determined by the user's behavior or emotional state. During and after the tutorial, the user can provide feedback to the terminal regarding clarity and effectiveness. The terminal records such user input, along with usage behavior and, if permitted, emotional state estimation data, and transmits it to the server. The server analyzes this feedback and accumulated usage data to autonomously update its processing algorithms, improve the explanation content, and refine the presentation methods for future users. As a concrete example, an engineer working with a parts transport robot may enter the following question into the terminal: “How is the stop operation of the parts transport robot implemented?” The server then parses the inquiry, searches relevant function definitions and design documentation, and generates a detailed yet simplified explanation together with educational code samples. If the server detects that the engineer is experiencing confusion (for example, based on query wording or behavior), the server automatically adds visual aids and more granular instructional steps to the response. An example of a prompt sentence for a generative AI model is as follows: “Analyze the source code of a factory robot to extract the design patterns used for specific operations. Then, generate an interactive tutorial code sample that helps new engineers quickly understand and experiment with the core functionalities, such as the stop operation of a parts-transport robot.”

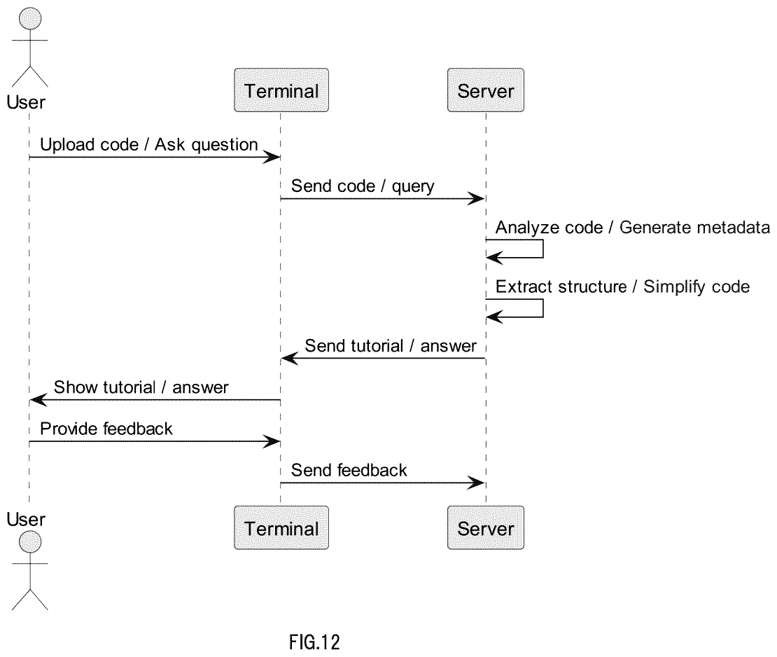

The following describes the processing flow using FIG. 12.

### Step 1

The server receives the complete program data set for an industrial system, typically uploaded via an input interface or synchronized from a version control repository. As input, the server obtains multiple source code files, configuration files, and related project documentation. The server then automatically parses each file using language-specific parsing libraries (such as Python's ast or generic parsing tools), extracting function definitions, class structures, comments, and module dependencies. The server processes this data by analyzing file content, mapping inter-module references, and identifying the functionality of each element. As output, the server generates structured metadata summarizing functional elements and their interrelationships, which is stored in a database for further processing.

### Step 2

The server analyzes the metadata to extract system-level organizational patterns and structural concepts. Input to this step is the metadata produced in Step 1, which includes function lists, interdependencies, and document annotations. The server applies a graph analysis library to organize modules and their relationships into a network structure, identifying central components, clustering similar features, and recognizing common design patterns. The output is an abstracted structural concept, represented as a set of key modules and relationships, often visualized as a network diagram or stored as a high-level map in the metadata.

### Step 3

The server generates simplified learning data based on the structural concept and attribute information. The input is the structural concept along with selected relevant code and documentation. The server extracts or synthesizes reduced versions of code fragments, removes non-essential logic, and adds explanatory annotations to highlight the functioning of each critical part. The server uses generative AI models or custom rule-based scripts to create annotated educational content. The output is a set of educational code samples and instructional text files optimized for user comprehension.

### Step 4

The terminal receives the educational content from the server as input, which includes simplified code, structural diagrams, and explanatory notes. The terminal presents this content interactively to the user, allowing the user to execute code snippets in a controlled sandbox environment, step through the logic, and observe real-time outcomes via the terminal's interface (e.g., smart glasses or tablet). As output, the terminal generates logs of user interactions, current tutorial progress, and any additional queries or feedback sent by the user.

### Step 5

The user initiates queries or asks specific questions using the terminal input mechanism, such as voice, text, or touch. The user's input consists of natural language inquiries about software functions or operation concepts (for example, “How is the stop operation implemented? ”).

The terminal transmits the user's inquiry to the server. The user's action results in the terminal outputting a query packet to the server for further processing.

### Step 6

The server processes the user's inquiry by applying natural language processing and searching its metadata and structural concepts for relevant functions and explanations. The server may invoke a generative AI model using a suitable prompt sentence (such as, “Extract the implementation of the stop operation and generate a simple, annotated explanation. ”). The input is the user's query and the server's stored metadata. The output is a tailored response, including explanations and illustrative code, sent back to the terminal.

### Step 7

The server estimates the user's emotional state by analyzing the query content, interaction patterns, and additional signals (such as hesitation or repeated requests). The input includes text data, usage metrics, or vocal cues. The server uses a trained machine learning model for emotion recognition. Based on the estimated emotional state, the server modifies the content or adapts the guidance level (for example, adding more detail if confusion is detected). The output is an updated set of instructional materials and an adjustment signal sent to the terminal.

### Step 8

The terminal presents the adapted content and guidance to the user based on the server's instructions. The input is the updated learning data, instructions, and emotion-related adaptations received from the server. The terminal dynamically alters the pacing, level of detail, or format of the content, providing personalized educational support. As output, the terminal logs continued user progress and collects further input and feedback.

### Step 9

The user provides explicit feedback through the terminal at various stages, such as confirming task completion or rating content clarity. The input is user-generated evaluation data or comments. The terminal forwards this feedback, together with interaction and emotional data logs, to the server.

### Step 10

The server aggregates and analyzes feedback, interaction records, and emotional state estimations from multiple users as input. The server uses this data to iteratively optimize its learning data generation algorithms, explanation content, and tutorial presentation methods. The output is a continually improving adaptive learning system that delivers personalized and efficient support for present and future users.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In information processing systems, it is challenging to rapidly and accurately understand the function and interrelation of each software program, especially as systems grow in size and complexity. New participants often face difficulties in comprehending system architecture and contribute efficiently to projects. Additionally, conventional systems lack responsive mechanisms to adapt instructional content based on the emotional or psychological state of users, resulting in inadequate support and decreased user satisfaction. Furthermore, there is a need for continuous improvement of the system based on user feedback and behavioral data to optimize user experience and educational effectiveness.

The specific processing by the specific processing unit 290 of the data processing device 12 in Example 2 is realized by the following means.

The present invention provides a server comprising a processor configured to mechanically analyze computer programs to identify their function and interrelation, extract system design guidelines from program attribute data, generate prompt sentences for a generative artificial intelligence model, analyze and adapt to the user's psychological state, dynamically adjust instructional and response content, and continuously collect and apply user evaluation information to improve system functions. This enables rapid understanding of software structure, efficient onboarding and education of new participants, adaptive and emotionally-responsive support for users, and evolutionary optimization of user experience and system performance.

The term “computer program” refers to a set of coded instructions or statements that are executed by a computing device to perform specific functions or operations. The term “mechanically analyze” refers to the process of automatically examining or parsing data or code using computational algorithms and tools without human intervention. The term “function” refers to the specific role, purpose, or behavior that a component, program, or module performs within a system. The term “interrelation” refers to the manner in which different components or data elements are interconnected or interact with each other within a system. The term “attribute data” refers to metadata or descriptive information that characterizes the properties, features, or behavioral aspects of a program or its components. The term “design guidelines” refers to the fundamental principles, rules, or strategies that govern the architecture, structure, or operational philosophy of a system. The term “generative artificial intelligence model” refers to a computational system or algorithm capable of producing new information, content, or explanations by learning from existing data. The term “prompt sentence” refers to an instruction or input statement provided to a generative artificial intelligence model to guide or specify the content or format of its output. The term “explanation data” refers to information, text, or materials generated to provide understanding, clarification, or detailed description of a subject. The term “instructional information” refers to content designed to teach, guide, or facilitate the user's understanding and effective use of a system or function. The term “user input information” refers to any data, queries, commands, or expressions provided by the user to a system for processing or response. The term “psychological state” refers to the emotional, cognitive, or mental condition of a user as inferred from their interactions with a system. The term “response content” refers to the information or output generated by the system in reply to a user's query or action. The term “educational content” refers to materials or resources intended to instruct, inform, or guide users in learning about a system or topic. The term “evaluation information” refers to feedback, ratings, comments, or any form of assessment provided by a user in response to their experience with the system. The term “processing system” refers to an assemblage of hardware and software components that collaborate to collect, analyze, generate, and deliver information or services.

A server is configured with a processor, memory, storage, and a network interface.

The server executes software components that are responsible for analyzing computer programs, handling user information, managing prompt sentence generation, and interacting with a generative artificial intelligence model. Specifically, the server operates with operating systems such as a general-purpose server OS (for example, Linux) and integrates code analysis tools (such as Source Insight or a static analysis application), sentiment analysis software (for example, an open-source NLP library), a database management system (such as a relational database), and an interface to a generative artificial intelligence model (such as a commercially available language model API). The server automatically scans and analyzes all software code within a target information processing environment. During analysis, the server extracts attribute data such as functional descriptions, dependence relationships, and other metadata from each program file. This data may be stored in a relational database for further processing. The server further extracts design guidelines for the entire information processing apparatus based on the collective attribute data. When a user accesses the system from a terminal device (e.g., a smartphone, tablet, or PC equipped with a web browser or dedicated client software), the user may enter a natural language query or operational request. The terminal captures the user's input data—which may include typed queries, selection actions, and behavioral context—and transmits this information to the server. Upon receiving the user input, the server analyzes the content, using sentiment analysis or emotion recognition tools, to estimate the psychological state of the user. The server then formulates a prompt sentence that reflects the attribute data of the relevant program, system design guidelines, the user's intention, and emotional state. This prompt is transmitted to the generative artificial intelligence model, which produces tailored explanation data or instructional content. The server adapts the educational or response content to the inferred psychological state of the user. For example, if the server detects confusion or frustration, it generates more detailed explanations, includes visual guides, or offers additional step-by-step assistance. The response content is sent to the terminal. The terminal displays the received instructional or explanation data to the user in the form of interactive guides, diagrams, or multimodal educational materials. The user can proceed through the content, interact with visual elements, or request further clarification. During this process, the terminal may adjust the speed or depth of instruction depending on the user's feedback or real-time behavior. The user may provide evaluation information or additional queries through the interface. The terminal collects this user feedback and transmits it to the server. The server then continuously aggregates and analyzes these responses to improve system performance and educational effectiveness. This includes updating program attribute data, adjusting prompt sentence templates, and, if necessary, retraining or tuning the generative artificial intelligence model used by the server. A concrete example is as follows: the user submits a question such as, “How do I configure the system to send email notifications?” The terminal sends this query to the server. The server analyzes software modules related to email functionality, generates a prompt sentence such as, “Given the user is confused about email notification configuration, generate a step-by-step guide that references the design choices and best practices implemented in the notification module. Make the explanation beginner-friendly and include a setup diagram.” The generative artificial intelligence model then creates a guidance text with visual aids, and the server sends the response back to the terminal, where the user receives and interacts with the instructions. Through these coordinated processes, the system provides rapid understanding of program structures, emotionally adaptive and educational support for users, and evolutionary optimization of the user experience.

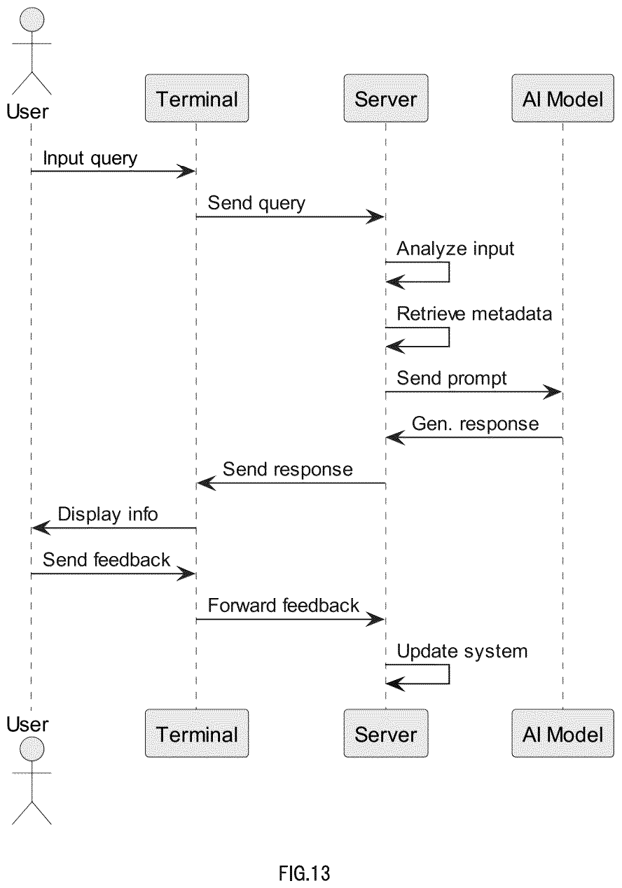

The following describes the processing flow using FIG. 13.

### Step 1

User accesses the terminal device and enters a query or request related to the system, such as a technical question or a request for guidance. The input is typically in natural language or through a selection from the interface. The input consists of user-entered text, button clicks, and navigation behavior. The output is the creation of an event data record containing the user query and interaction context.

### Step 2

The terminal receives the user's input, packages the input data together with contextual information (such as current screen or session data), and transmits this event data to the server via a secure network protocol. The input is the raw user query and related context, and the output is a structured transmission of this data to the server.

### Step 3

The server receives the input data from the terminal and performs preprocessing, such as parsing the text, filtering out irrelevant information, and standardizing formats. The input is the data record from the terminal; the output is a parsed and preprocessed data object ready for analysis.

### Step 4

The server analyzes the preprocessed data using natural language processing tools to determine the user's intent (e.g., identifying a request for email configuration guidance) and employs sentiment analysis or emotion recognition modules to estimate the user's psychological state (e.g., confusion or frustration). Based on these analyses, the server produces structured data indicating intent and emotional state as output.

### Step 5

The server accesses a code analysis database or repository metadata store where all computer programs have been previously scanned. The input is the identified user intent (e.g., a relevant module or topic); using this input, the server retrieves associated program metadata, such as descriptions, interrelations, and dependencies. The output is a set of attribute data and design guidelines relevant to the user's query.

### Step 6

The server constructs a prompt sentence for a generative AI model, incorporating user intent, emotional state, and the retrieved program metadata. The input is the aggregated attribute data, design guidelines, intent, and emotion. The server then sends this prompt to the generative AI model via an API call. The output is the AI-generated explanation or instructional content tailored to the user and query.

### Step 7

The server adapts the generated content according to the inferred psychological state—for example, by adding step-by-step instructions, diagrams, or using encouraging language if the user is frustrated. The input is the AI-generated content and the user's psychological state; the output is a refined response package, which may include multimedia resources, to be sent back to the terminal.

### Step 8

The terminal receives the response from the server and presents it to the user through the user interface. The input is the instructional or explanation data; data processing involves selecting the optimal presentation format (such as interactive guides or visual aids). The output is an instructional display experienced by the user.

### Step 9

User reviews the presented information and may provide feedback or follow-up questions through the terminal interface. The input is the displayed guidance, and the output is user-generated feedback or new queries sent via the terminal.

### Step 10

The terminal collects feedback or new queries from the user and transmits this information to the server for further analysis. The input is feedback data or additional queries; the output is a structured data packet delivered to the server.

### Step 11

The server aggregates user feedback, performs analytic processing to detect trends or recurring issues, and updates prompt sentence templates or system parameters as necessary. The input is ongoing user feedback and behavioral data, and the output is an updated knowledge base and optimized instructional strategies for future user interactions.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

In conventional information processing systems used in education and project management, there is insufficient capability to provide adaptive and interactive experiences tailored to the psychological state or emotional status of users. As a result, new participants may face difficulties in progressing through learning or project tasks, and the overall satisfaction and understanding of users may decrease due to the system's inability to dynamically adjust content or interaction based on user emotions. Furthermore, current systems often lack effective tools for automatic program data analysis, structural concept extraction, and personalized instructional support. There exists a need for a technology that can not only analyze complex program data and generate comprehensive yet comprehensible representations of a system's structure, but also recognize user psychological states and leverage this information to adjust interactions in real time.

The specific processing by the specific processing unit 290 of the data processing device 12 in Application Example 2 is realized by the following means.

The present invention provides a server comprising a processor configured to automatically scan all program data, identify attributes and relationships of each data file, extract configuration information and generate a structural concept of the entire system, generate an educational simplified version of program data while retaining core functions, acquire verification data from a user and identify the user's psychological state using a recognition processing apparatus, dynamically adjust interaction content according to the user's psychological state, and automatically generate input sentences for a generative information processing model based on the recognized psychological state and structural concept. This enables real-time adaptive instructional interaction that considers the user's psychological state, improves learning and project navigation for new participants, and facilitates comprehensive system understanding by providing context-aware responses and instructional content.

The term “program data” refers to any set of instructions, code files, or data structures used in the operation or development of an information processing system. The term “attributes” refers to characteristic properties or metadata of individual program data files, such as function names, data types, creation dates, or authorship. The term “relationships” refers to logical or functional dependencies or connections between elements or files within program data, such as function calls, class inheritance, or module import references. The term “configuration information” refers to information extracted from program data that describes the structural or architectural arrangement of an information processing system, including components, dependencies, and connectivity. The term “structural concept” refers to an abstract representation or model of the overall system organization, functionality, and design philosophy derived from configuration information. The term “educational simplified version of program data” refers to a reduced or modified set of program data that maintains the core functionalities of a system but is easier to understand for instructional or learning purposes. The term “verification data” refers to biometric or interaction-based data, such as facial expressions, voice signals, or user inputs, acquired from a user to facilitate identification or state recognition. The term “user's psychological state” refers to the emotional or cognitive condition of an individual interacting with the system, such as stress, confusion, engagement, or satisfaction. The term “recognition processing apparatus” refers to any hardware or software component capable of analyzing verification data to determine the psychological state of a user. The term “generative information processing model” refers to an artificial intelligence algorithm or computational framework capable of producing content, responses, or instructions based on input sentences and contextual data. The term “input sentence” refers to a text prompt created for the generative information processing model, which encodes contextual or instructional information for response generation. The term “interaction content” refers to instructional materials, system responses, or user interface elements presented to the user, which may be adapted or modified according to user-specific or system-derived information. The term “reaction information” refers to the data representing the user's responses, feedback, or behavioral signals obtained during system interaction. The term “information processing system” refers to a computational environment comprising hardware and software components configured to process, store, and manage data to execute specified tasks.

An exemplary embodiment of the present invention is an information processing system designed to adaptively support instructional and project management tasks by analyzing program data, extracting structural concepts, and adjusting user interaction based on the psychological state of a user. The server is equipped with standard computing hardware (such as a multi-core central processing unit, memory, persistent storage, and network interfaces) and operates on a general operating system such as Linux. The server executes software components including programming language parsers (such as Python's ast module or Tree-sitter for multiple languages), data processing libraries (such as pandas), machine learning frameworks (such as TensorFlow or PyTorch), computer vision libraries (such as OpenCV), and natural language processing systems (such as a generative AI model). The server is configured to automatically scan all program data stored in the storage device. The server accesses each program file, parses its contents, and identifies various file attributes such as function names, data types, structural hierarchies, and authorship metadata. The server also determines the relationships among elements in the program data—such as function calls, class inheritance, or module dependencies. Based on the extracted attributes and relationships, the server generates configuration information describing the structure of the entire information processing system. Using this configuration information, the server creates a structural concept, which may comprise an abstracted model or textual summary of how the system operates and how its components interact. The server further generates an educational simplified version of the program data by selecting and summarizing essential functions and logic, omitting details unnecessary for educational purposes but preserving core functionalities. To support adaptive user interaction, the server receives verification data from the terminal. The terminal is a user device (such as a smartphone or smart glasses) equipped with a camera and microphone interfacing with the server via a secure network connection. The terminal continuously captures the user's facial expressions and voice. The terminal transmits this biometric data to the server for analysis. Upon receiving the verification data, the server utilizes the recognition processing apparatus, which may include OpenCV for facial feature extraction and a machine learning model (such as a convolutional neural network implemented in TensorFlow) for emotion classification. Speech data is transcribed by speech recognition software (such as an open-source speech-to-text framework), and a sentiment analysis module is used to infer the user's psychological state. If the user is determined, for example, to be confused or stressed, the server dynamically adjusts the instructional content and interaction. This may include slowing the presentation speed on the terminal, generating additional supplementary guides, or activating supportive auditory content (e.g., calming background music). The server generates an input sentence, also known as a prompt sentence, for the generative AI model. This prompt sentence describes the user's psychological state and the current instructional objective, prompting the AI model to supply appropriate content or guidance. For instance, if the user is struggling with an intermediate-level problem, the following prompt sentence may be generated: “The user appears confused by an intermediate-level problem. Please generate a detailed visual walkthrough guide for this problem, and provide calming background music suggestions to decrease user stress.” The terminal receives content and instructions from the server and updates its user interface accordingly. The terminal may display detailed explanatory guides, highlight specific steps, and play selected audio content. Throughout this process, the server continuously collects reaction information and updated psychological state assessments from the user. The server uses this data to optimize instructional strategies and system functions in real time, thus enhancing the user's learning efficiency and experience. This embodiment can be implemented using widely available hardware components and open-source or commercially available software frameworks. The generative AI model referenced herein can be instantiated on the server or accessed via an external computational resource. The above example illustrates just one possible application of the present invention. Additional variations and modifications can be implemented within the scope of the claims.

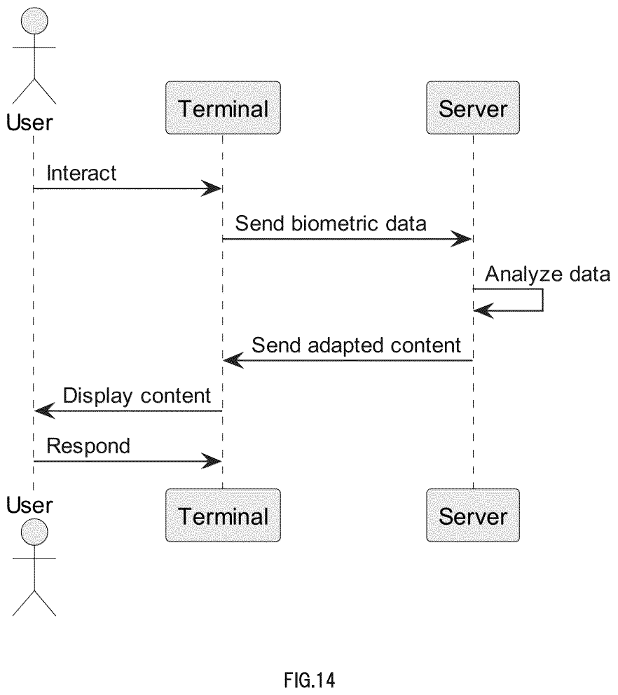

The following describes the processing flow using FIG. 14.

### Step 1

The server initiates a full scan of all program data stored within its storage system. The input is the set of program data files. The server parses each file using programming language parsers, identifying attributes (such as function names, variable types, and metadata) and relationships (such as function calls, class inheritance, or module dependencies) between code elements. The output is a structured dataset containing the extracted attributes and relationships. This involves reading each file, analyzing its syntax tree, and recording detected structures into an internal database.

### Step 2

The server processes the structured dataset to extract configuration information and generate a structural concept of the entire information processing system. The input is the dataset containing attributes and relationships from Step 1. The server uses information aggregation and abstraction algorithms to model component interconnections and system-level architecture. The output is a textual summary or conceptual model representing the system's design. The server further generates an educational simplified version of the program data by selecting core modules and summarizing complex logic into easier-to-understand forms.

### Step 3

The terminal captures real-time verification data, such as video and audio, from the user during system interaction. The input is user behavior in front of the terminal, which triggers the terminal's camera and microphone to record facial expressions and voice samples. The terminal preprocesses and transmits the data to the server over a secure connection. The output is a stream of biometric data sent to the server for analysis.

### Step 4

The server receives the verification data and uses the recognition processing apparatus to identify the user's psychological state. The input is the biometric data stream from Step 3. The server utilizes facial feature extraction (via computer vision libraries) and speech analysis (via speech-to-text and sentiment analysis modules). These data are processed to detect emotional cues such as confusion, stress, or engagement. The output is a classified psychological state (e.g., “confused,”“relaxed,”etc.) associated with the user session.

### Step 5

The server dynamically adjusts the content and interaction strategy in response to the recognized psychological state. The input is the classified psychological state, the system's structural concept, and the user's current learning or project task. The server generates prompt sentences for the generative AI model that reflect both the psychological state and the instructional context, such as: “The user appears confused by an intermediate-level problem. Please generate a detailed visual walkthrough guide for this problem, and provide calming background music suggestions.” Based on the generative AI model's output, the server prepares customized instructional content (such as stepped guidance, additional explanations, or recommended audio content). The output is a package of adapted instructional materials and guidance instructions.

### Step 6

The terminal receives the adapted content package and updates its user interface accordingly. The input is the package of instructional materials and guidance instructions from the server. The terminal displays detailed explanations, visual guides, step-by-step animations, or supportive audio. The output is an updated interactive environment provided to the user, including new media or UI components.

### Step 7

The user interacts with the presented content, engaging with the instructional material. The input is the personalized content and interface presented on the terminal. The user responds by performing actions (such as answering questions, clicking navigation buttons, or expressing emotion through facial or vocal cues). The output is a set of behavioral and emotional reactions observable by the terminal, which are then used as input for Step 3, thus enabling an adaptive feedback loop.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

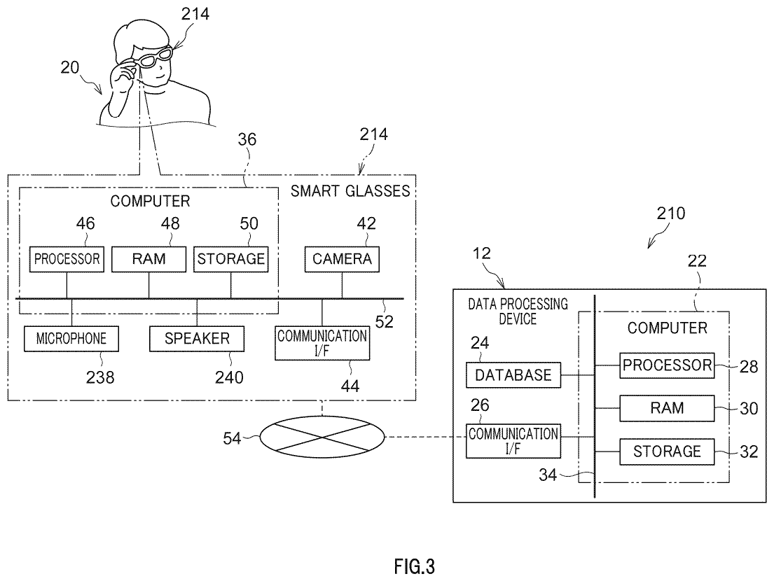

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

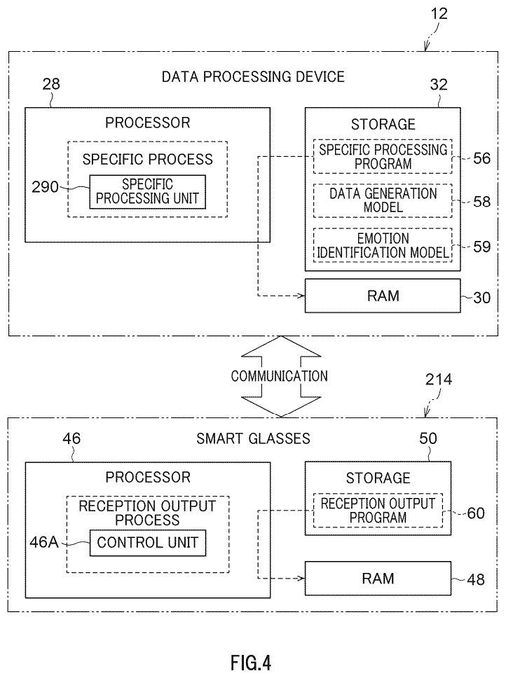

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

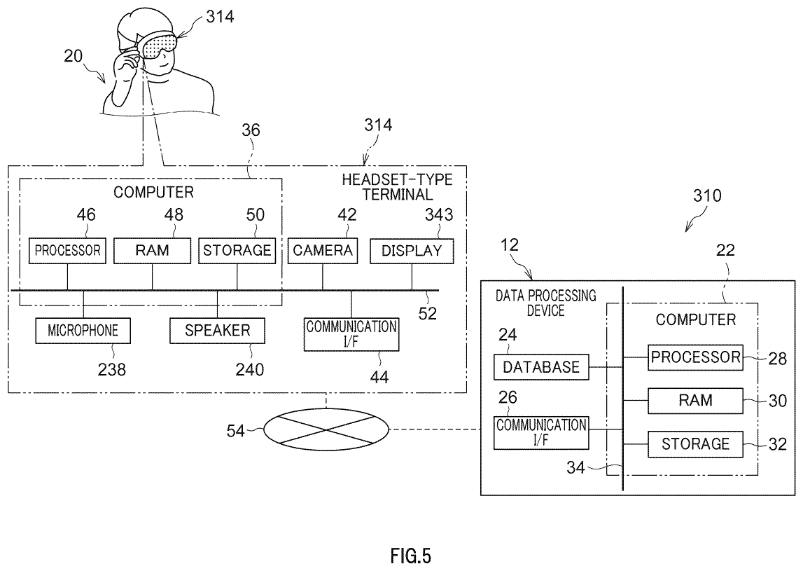

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

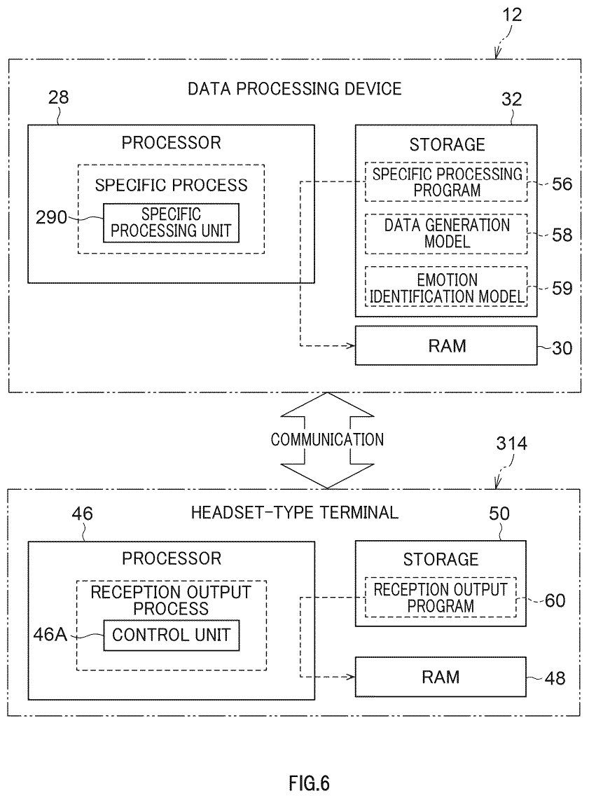

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

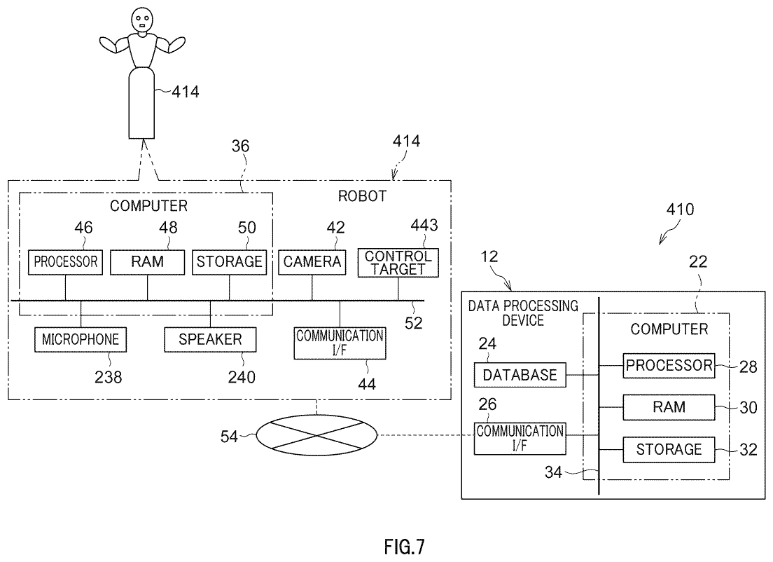

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

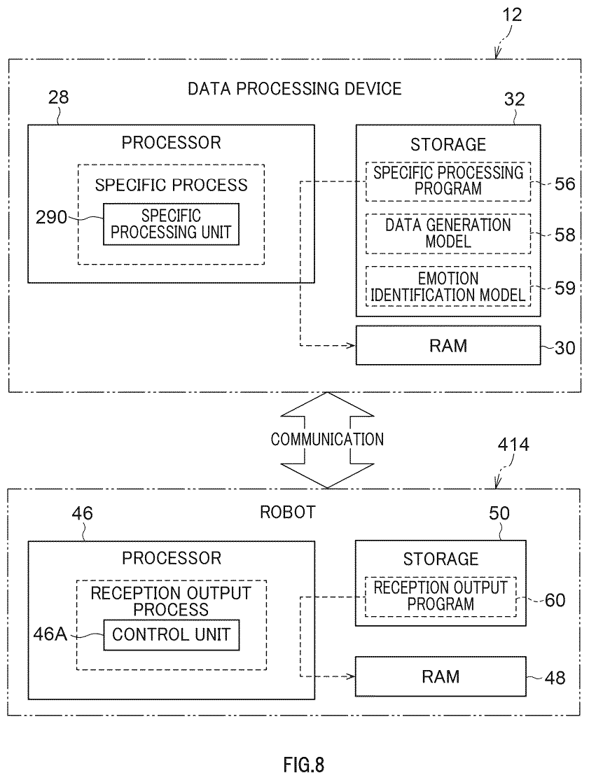

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

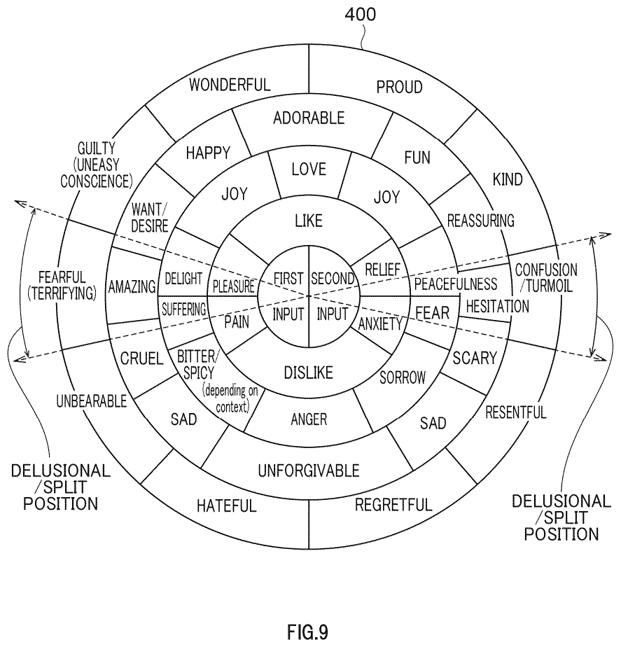

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety.

Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

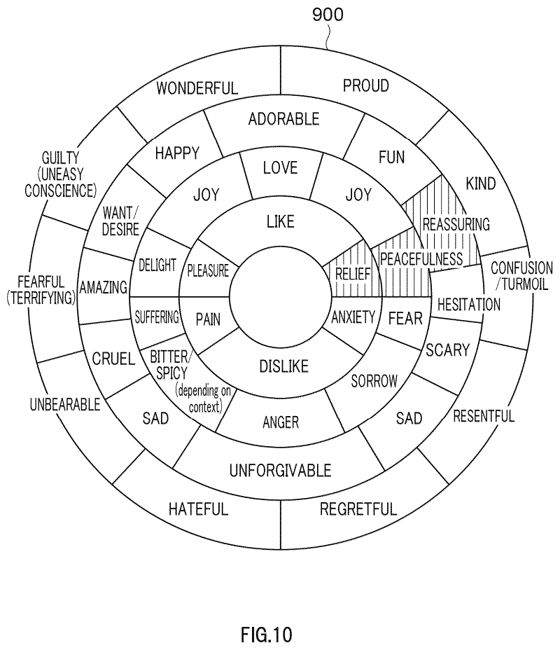

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### Supplementary 1

A system comprising a processor, wherein the processor is configured to automatically scan a plurality of software code description data and identify functions and interrelationships of each software code description data, extract a design policy of the entire information processing system based on structural information of the analyzed software code description data, generate, using the extracted design policy and structural information, a reduced learning software code description data that retains basic information processing operations of the information processing system, provide an interactive educational information processing environment on a terminal device based on the reduced learning software code description data, accept a question sentence data from a user, generate a prompt sentence including the question sentence data, the design policy information, and the structural information, input the prompt sentence to a generative model, and automatically generate explanation information and specific example information based on the design policy of the project as a response result.

### Supplementary 2

The system according to supplementary 1, wherein the processor is configured to provide stepwise instructional teaching materials for new users on the terminal device based on the analyzed structural information and design policy information.

### Supplementary 3

The system according to supplementary 1, wherein the processor is configured to collect response information and operation history information from the user, and automatically update or improve functions in the information processing apparatus based on the collected information.

### Application Example 1

### Supplementary 1

A system comprising a processor, wherein the processor is configured to analyze, by an information processing apparatus, all program data composed of electronic information, and to identify functional elements and interrelationships of each stored data; extract a structural concept of the entire configuration using processed attribute information; automatically generate simplified learning data while maintaining core functions based on the attribute information and the structural concept to facilitate understanding; analyze an inquiry received from an external input device, and generate response information using the extracted structural concept and related stored data; adaptively adjust the output information or simplified learning data in accordance with an estimated emotional state of a user determined by a machine learning model; dynamically present the generated simplified learning data and response information to the user through an interactive control device; collect user input history and estimated emotion data, and optimize the processing methods or generation rules of each function based on accumulated information.

### Supplementary 2

The system according to supplementary 1, wherein the processor is configured to sequentially present the simplified learning data and interactive content based on the extracted attribute information and structural concept to a new participant, and to modify the content or progression control according to behavioral history and emotion estimation result.

### Supplementary 3

The system according to supplementary 1, wherein the processor is configured to autonomously update the overall processing algorithms, explanation content, and presentation methods of the system based on evaluation information and emotion estimation data acquired from the user.

### Example 2

### Supplementary 1

A system comprising a processor, wherein the processor is configured to mechanically analyze all computer programs to identify the function and interrelation of each program data, extract design guidelines of an information processing apparatus based on the attribute data of the analyzed program information, generate prompt sentences for a generative artificial intelligence model based on the attribute data and the design guidelines, and generate explanation data or instructional information by considering user input information and emotional state, analyze user operation information and language information to identify the psychological state of the user, dynamically adjust response content or educational content in accordance with the psychological state of the user, continuously collect evaluation information and response information from the user and automatically improve the functions of the processing system.

### Supplementary 2

The system according to supplementary 1, wherein the processor is configured to provide adaptive operation guidance or interactive teaching materials in accordance with the psychological state of the user based on the analyzed and extracted information and the data generated by the generative artificial intelligence model.

### Supplementary 3

The system according to supplementary 1, wherein the processor is configured to analyze continuous behavioral information and evaluation information of the user and evolutionarily optimize the user experience or educational functions of the information processing apparatus.

### Application Example 2

### Supplementary 1

A system comprising a processor, wherein the processor is configured to automatically scan all program data to identify attributes and relationships of each data file, extract configuration information from the analyzed program data and generate a structural concept of the entire information processing system, generate an educational simplified version of program data while retaining core functions of the information processing system based on the configuration information, acquire verification data from a user and identify the user's psychological state using a recognition processing apparatus, dynamically adjust interaction content with the information processing system according to the user's psychological state, automatically generate an input sentence for a generative information processing model based on the recognized psychological state and the structural concept, and acquire a response, and generate a response to a user's inquiry based on the structural concept of the entire system.

### Supplementary 2

The system according to supplementary 1, wherein the processor is configured to provide interactive instructional information based on the extracted configuration information and the user's psychological state.

### Supplementary 3

The system according to supplementary 1, wherein the processor is configured to continuously collect reaction information and psychological state from the user and optimize the functions of the information processing system.

What is claimed is:

1. A system comprising a processor, wherein the processor is configured to:
automatically scan all software code and identify the role and relationships of each code file;
extract the overall design concept of the system based on metadata of the analyzed code;
generate educational reduced code that retains the core functions of the project while making it easier to understand; and
generate answers to user questions based on the overall design concept of the project.

2. The system according to claim 1, wherein the processor is configured to provide an interactive tutorial for new participants based on the analyzed and extracted information.

3. The system according to claim 1, wherein the processor is configured to continuously collect user feedback and include means for improving system functionality based on the feedback.
